(19) United States
(12) Patent Application Publication
(10) Pub. No.: US 2021/0122622 A1
(43) Pub. Date: Apr. 29, 2021

(54) REMOTE CONTROLLED BEVERAGE DISPENSING SYSTEM

(71) Applicant: CARLSBERG BREWERIES A/S, Copenhagen V (DK)

(72) Inventors: Jonas CHRISTIANSEN, København V (DK); Thomas Berg SCHOLTE, Copenhagen V (DK); Peter BACH, Copenhagen V (DK)

(73) Assignee: Carlsberg Breweries A/S, Copenhagen V (DK)

(21) Appl. No.: 17/041,484

(22) PCT Filed: Mar. 28, 2019
(86) PCT No.: PCT/EP2019/057949

§ 371 Date: Sep. 25, 2020

(30) Foreign Application Priority Data
Mar. 28, 2018 (EP) 18164478.2

(51) Int. Cl. B67D 1/07; B67D 1/06

(52) U.S. Cl. CPC B67D 1/07; B67D 1/0462; B67D 1/06

(57) ABSTRACT

The present invention relates to a beverage dispensing system (10) comprising a beverage dispensing region (2) for a drinking establishment, said beverage dispensing region (12) including a plurality of beverage containers (20a, 20b, 20c, 22a, 22b, 22c) and one or more tapping heads (34) for dispensing beverage, the one or more tapping heads (34) having a beverage dispensing control means and a spout for dispensing beverage into a beverage recipient, wherein each of said plurality of beverage containers includes a beverage outlet in communication with said beverage, in which the beverage dispensing system further comprises a remote control means (16) being connected to a valve (18), said valve (18) being connected to a plurality of said beverage outlets for switching the dispensing of beverage from a first beverage container to a second beverage container and wherein said remote control means (16) and said valve (18) are located in the near vicinity of said one or more tapping heads (34).

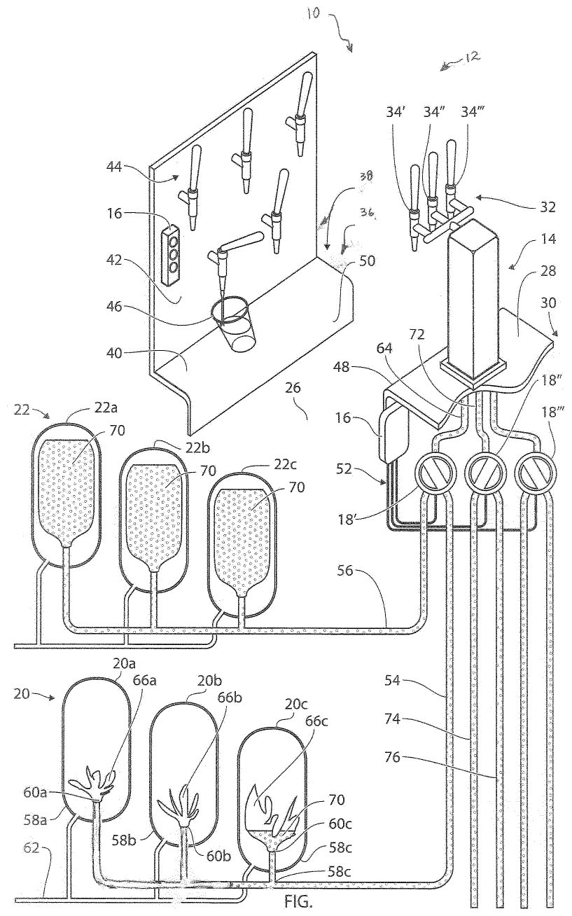

The present invention relates to a beverage dispensing system comprising a plurality of beverage containers for remote initiation of the dispensing of beverage from such beverage containers

### BACKGROUND OF INVENTION

Beverage dispensing systems are typically used in beverage dispensing establishments for efficiently dispensing large quantities of beverage. Typically, beverage dispensing systems are used to dispense carbonated alcoholic beverages such as draught beer and cider. However, also non-alcoholic beverages such as non-alcoholic beers, soft drinks and non-carbonated beverages such as wine and fruit juice may be dispensed using a beverage dispensing system. Beverage dispensing systems are mostly for professional users such as in establishments like bars, restaurants and hotels, however, increasingly also for private users such as in private homes.

Professional beverage dispensing systems typically dispense beverage provided in large beverage kegs. Such beverage kegs may hold 20-50 L of beverage or even up to 500 L for a professional beverage dispensing system for allowing typically 50-100 beverage dispensing operations before needing to exchange the beverage keg. Typically, beverage kegs are made of solid materials such as steel and re-filled a number of times. In between each filling the beverage kegs are carefully cleaned. Insufficient cleaning may lead to unhygienic beverage kegs, which may in turn lead to health problems for the beverage consumer. Alternatively, beverage kegs are made collapsible for single use only, at least in part due to the above hygiene concern.

An example of such a beverage dispensing system using collapsible beverage kegs is the DraughtMaster™ system provided by the applicant company. Such beverage dispensing systems using collapsible beverage kegs typically have the beverage keg installed in a pressure chamber. During the dispensing of beverage from the pressure chamber, a pressure fluid from a pressure generating source such as an air compressor, acts on the collapsible beverage container (collapsible keg) and forces the beverage out. Thus, the beverage container collapses while dispensing the beverage and the volume of the beverage container is reduced corresponding to the amount of dispensed beverage. The collapsible kegs are preferably made of flexible and disposable material such as plastic.

While performing a dispensing operation, the force of the pressure causes the beverage to flow out of the beverage container and into a tapping line comprising one or more beverage lines. The tapping line leads to a tapping device comprising one or more tapping heads. The tapping head typically includes a tapping valve and a beverage dispensing control means such as a tapping handle for allowing an operator to control the tapping valve and thereby the beverage dispensing operation.

When a beverage container is nearly empty, several problems arise.

One problem is foam generation. Since standard beverage dispensing systems such as those using rigid kegs, e.g. steel kegs, comprise carbonated beverage and pressurized gas, when the beverage container is nearly empty, a significant amount of gas may enter the beverage line and mix with the remaining beverage in the beverage line, which may result in a large amount of foam escaping from the beverage tap during tapping. A beverage glass filled with an excessive amount of foam may be less appealing and must in many cases be discarded. Further, foam may remain in the beverage line so that the first beverage glass filled after installing a new and full beverage container will have an excessive amount of foam as well.

In systems which lead the beverage via a common dispensing line that ends up at a common tapping device, such as modular beverage dispensing systems comprising collapsible beverage containers, there is a problem that the beverage containers, due to small differences in the material of the container, in the volume of beverage and in the pressure applied, although starting out full, will be empty at different times. When a beverage container is empty, the gas filled head space, or simply head space, remains and it is inevitably that gas will be injected into the beverage line as the head space is collapsed. This gas generates foam which will enter the tapping line and mix with the beverage from the other beverage containers which may not be empty. By replacing the empty beverage container, it will not be long until the next one is empty and the line is again filled by foam. Thus, in effect it is the first empty beverage container which determines when the beverage containers must be replaced even though several liters of beverage may remain in the non-empty beverage containers.

Another problem is that when a beverage container is nearly empty, the beverage line has to be switched to a non-empty beverage container. Normally, the operator or user, e.g. a bartender, would be required to go to the place where the beverage containers are located and locally there conduct the exchange of the tapping line, suitably by means of a valve located in the near vicinity of such beverage containers. Normally, such beverage containers are a significant distance from the tapping heads. For instance, the beverage containers may be located far away from the bar counter, i.e. at remote locations, typically in basements or at least separate rooms or locations requiring physical displacement of the operator from the bar counter. Since the condition of having empty beverage containers (kegs) often takes place in busy periods at the bar counter, it is highly undesirable for the operator and/or the customer waiting for his/her beverage, to wait until the operator fixes a beverage line into a non-empty container.

GB 2 180 917 relates to an electro mechanical rotary valve which can be installed in any public house enabling the publican to connect three barrels of beer and a gas cylinder, to the dispensing point.

U.S. Pat. No. 4,247,018 relates to a non-pressurized fluid transfer system for stock rotation of liquids packaged in large non-pressurized containers.

WO 2016/026693 relates to an “under the counter” dispensing unit according to an embodiment of the present disclosure with several containers connected to a same dispensing tap.

JP 2002068379A relates to a domestic drink server for pouring beverages in beverage containers such as cans and bottles by gas pressure.

JP 2017503725A relates to beverage supply apparatus for supplying different types of beverage or beverage ingredients.

EP 222729B1 relates to beer tapping device having a tapping point, which is connected via a tapping line to a beer supply, which has a plurality of containers.

EP 322729A1 relates to an apparatus that serves for dispensing beverages under pressure. An intermediate container with level switch is connected to a plurality of storage containers for the beverage and to a line leading to a dispensing tap.

U.S. Pat. No. 3,738,388 relates to a valve system for selectively connecting a single dispensing tap or outlet with a selected one of a plurality of fluid supply sources.

U.S. Pat. No. 3,878,970 relates to a method of dispensing beer out of a single faucet from one, or from a number of kegs separately connected by suitable ducts with a header communicating with the faucet.

WO 2007107704A1 relates to a beverage dispenser in which a carbonated beverage is dispensed through a delivery valve into a delivery tube leading to a spigot.

DE 202006010613U1 relates to a feeder device for supplying a mixed drink from a supply selection while fitted with a pipe for removing the mixed drink from the supply selection and transferring it via a delivery device into a delivery selection. There is a device like a float/conductivity sensor for recognizing if the supply selection is empty.

WO 2017097820A1 relates to a beverage font comprising a mixing conduit having a first inlet for receiving a pressurized beverage defining a first alcoholic percentage and a second inlet for receiving an additive defining a second alcoholic percentage.

U.S. Pat. No. 5,909,825 relates to a beverage dispensing system permitting an uninterrupted flow of a beverage including a first and second beverage containers and a dispenser connected to the containers. The corresponding valves therein are not located in the near vicinity, e.g. integrated in the bar counter, and thereby near the tapping head.

GB 1474237A relates to a beer dispensing system including a detector for detecting when a beer supply has become exhausted and valve means for connecting any one of a plurality of beer supply kegs with a keg holding a supply of beer.

U.S. Pat. No. 3,625,399 relates to a beer dispensing system for dispensing beverage from another beverage container when the container from which the beverage being dispensed is empty. An electrical circuit is actuated by a selector control unit remote from barrels containing the beer (rigid beverage containers) to simultaneously operate solenoid valves to open a line from one barrel to a tap. The selector control unit is located on or adjacent to the tap chest, while the solenoid valves are adjacent the barrels.

GB 2505903A discloses a device for dispensing beverage left in dispense lines using pressurized gas, in which a controller is located near the beverage dispenser or bar area, yet a valve manifold is located in the beverage store area where the beverage stored devices are located.

GB 2298462A in the same manner as U.S. Pat. No. 3,625,399 discloses a beverage dispensing apparatus where a switch is operated by a user near the dispensing outlet, i.e. beverage tap, yet the corresponding valves are adjacent the barrels (beverage containers).

It is an object of the present invention to provide continued beverage supply at the beverage dispensing region.

It is another object of the present invention to allow the operator or user in a simple manner to rapidly change from one beverage container to another beverage container, e.g. from empty to full beverage containers.

These and other objects are solved by the present invention.

### SUMMARY OF THE INVENTION

According to a first aspect of the present disclosure, there is provided a beverage dispensing system comprising a beverage dispensing region for a drinking establishment, said beverage dispensing region including a plurality of beverage containers and one or more tapping heads for dispensing beverage. Preferably the one or more tapping heads comprise a beverage dispensing control means and typically a spout for dispensing beverage into a beverage recipient. Each of said plurality of beverage containers may include a beverage outlet in communication with said beverage. Advantageously the beverage dispensing system further comprises a remote control means, such as remote control button or switch. The remote control meams may be connected to a valve that is connected to a plurality of beverage outlets for switching the dispensing of beverage from a first of said beverage containers to a second of said beverage containers, e.g. switching the dispensing of beverage from an empty beverage container to a full beverage container. Preferably the remote control means and said valve are located adjacent to and/or in the near vicinity of said one or more tapping heads. I.e. such that it is in the range of a person operating one of said tapping heads can easily operate the remote control means.

Hence, as used herein, the term “near vicinity of said one or more tapping heads” means: readily accessible to an operator located at a reaching distance of said one or more of said tapping heads, i.e. by the remote control means and valve or set of valves being integrated in the beverage side of a beverage counter, or in a bar counter, or in a beverage font assembly, as will become apparent from the below description and accompanying FIGURE. The operator is located in the operator side, as it also will become apparent from the below description and accompanying FIGURE, thus within reaching distance of the tapping heads.

The present invention enables therefore in a simple manner to change to an additional beverage container. As stated above the operator may choose to change beverage containers when convenient after a beverage container in one beverage line is empty, without needing to leave the bar area or point of sales. But the remote control and valve can also be a major advantage because it allows easy switching between different beverage types from the same tapping head, in particular switching between alcohol-free beer and normal alcohol containing beer, where the taste of the beverages are similar, for example such that alcohol-free beer can be served from a first tapping head for lunch and normal alcohol containing beer can be served from the same tapping head for the evening. I.e. the number of beverage types available in the bar can be increased without increasing the number of tapping heads.

In other words, the operator is now able to choose by own planning when to change the beverage containers and continue serving. The point of sales (POS) is the region of interface between the operator such as the bartender, and the customer. The operator side is part of POS.

The present invention provides therefore a crucial time buffer for the operator to change the supply of beverage, allowing him/her to stay with the customers, especially in busy periods, such as during special sport events, “happy hours”, and dinner servings.

### DETAILED DESCRIPTION OF INVENTION

The terms “beverage container” and “collapsible beverage containers” are used interchangeably throughout the description with “kegs” and “collapsible kegs”, respectively.

In one embodiment of the first aspect, said remote control means comprises a remote control button or switch. Preferably, there are a plurality of remote control buttons or switches. Each remote control button may then be associated to a particular beverage container and corresponding valve. A button or switch is easy to operate by providing an on-off functionality for each beverage container and thus particularly suitable.

In another embodiment of the first aspect, said remote control means is part of a touch screen and said touch screen provides a visual display of the content of beverage within a particular beverage container. Hence, a full beverage container will show 100% and a nearly empty container will show e.g. 5%. By touching the screen, the operator is able to remotely switch from the nearly empty or empty beverage container to a full beverage container.

In special events in a drinking establishment, operators may be tempted to serve more bottled beers than draught beers (dispensed from a tapping head), because with bottled beers the operator has much more control of how much beer is available. For draught beers, the operator is normally in doubt or has no control of the amount of beer left other than by counting servings or through sensors. Thus, the operator is tempted to go for the easy solution, which is the supply of bottled beers, thus reducing significantly the consumption of draught beer, or any type of beverage, being dispensed. By the present invention, this problem is significantly mitigated, as the operator gains control and knowledge of how much beer or any type of beverage is left in the beverage dispensing system. More draught beer may thereby be dispensed.

In another embodiment of the first aspect, said one or more tapping heads are mounted on a beverage counter, said beverage counter defining at least an operator side and a beverage side, said beverage side comprising at least one face, said one or more tapping heads protruding from the at least one face of said beverage side of said beverage counter, said one or more tapping heads being connectable to a tapping line comprising one or more beverage lines, said tapping line extending through said beverage side to any of said plurality of beverage containers, in which said beverage may flow from any of said plurality of beverage containers via said tapping line and said one or more tapping heads to said spout and from said spout to the beverage recipient, in which the at least one face is a vertical face and said one or more tapping heads are part of an assembly of tapping heads arranged along the horizontal direction of said vertical face.

Suitably the vertical face is in the form of a wall. The vertical face may also be a portion of a separate wall, for instance a panel embedded therein. The vertical face may also be curved. The vertical face enables better visibility by the bartender and customer of the beverages being poured from said tapping heads. It would also be understood that such wall may be a corrugated wall or a flat wall. The assembly of tapping heads comprises multiple tapping heads, e.g. 3-60, 5-50 tapping heads, each providing a different beverage such as a different beer.

In another embodiment of the first aspect, said one or more tapping heads are part of a beverage font in a beverage font assembly, said beverage font assembly comprising a bar counter, said beverage font being mounted in said bar counter, said bar counter defining an operator side and a customer side opposite said operator side, said one or more tapping heads having a spout and a beverage dispensing control means and being connectable to a tapping line comprising one or more beverage lines, said tapping line extending through said beverage font to any of said plurality of beverage containers, in which said beverage may flow from any of said plurality of beverage containers via said tapping line and said one or more tapping heads to said spout and from said spout to the beverage recipient.

As used herein, the term “drinking establishment” means an area or region where a beverage, in particular beer, is consumed, such as bars, pubs, cafés, canteens, restaurants, stadiums and private homes. The drinking establishment includes therefore the beverage dispensing system, while the beverage dispensing system includes a beverage dispensing region within which the POS exists associated with the beverage counter and/or bar counter. The beverage dispensing region includes also the font assembly.

In another embodiment of the first aspect, said beverage containers are collapsible beverage containers, preferably single use collapsible beverage containers. Single-use collapsible kegs are easier to handle compared to classic rigid kegs, in particular steel kegs, as the single-use collapsible kegs may be discarded, and are easier to exchange to a new full collapsible keg

It would be appreciated that the presently disclosed beverage dispensing system is without the use of classic FOB detectors. FOB detectors are otherwise known in the art to prevent foam formation in beverage lines. FOB detectors include normally a floater for allowing beverage to pass while preventing gasses to pass. FOB detectors may need to be adapted to every module and are therefore costly. Furthermore, FOB detectors are difficult to keep clean and thereby introduce a risk of contamination in the beverage dispensing system.

The plurality of beverage containers may include more than two collapsible beverage containers. The present beverage dispensing system according to the first aspect may in principle be expanded to any number of beverage containers which may be connected in series. In this way, the operator or user must not exchange the beverage container as often as by using two collapsible beverage containers. Further, the same pressure source and cooling source may be used for the plurality of pressure chambers encapsulating the collapsible beverage containers.

Hence, in another embodiment of the first aspect, the beverage dispensing system comprises between 3 and 50 beverage containers. The above numbers are particularly suitable for modular systems, being a compromise between being able to dispense a large amount of beverage in-between interruptions for changing containers and the cost of particularly the pressure chambers encapsulating the collapsible beverage containers.

In another embodiment of the first aspect, said plurality of beverage containers including a beverage outlet in communication with said beverage is part of a first and second set of beverage containers, each set comprising one or more beverage containers. Preferably, the beverage dispensing system further comprises at least a third set and fourth set of beverage containers, each set comprising one or more beverage containers. A valve, e.g. a first valve, is connected to a plurality of said outlets via a first tapping line associated with said first set, and a second tapping line associated with said second set. Another valve, e.g. second valve, is connected to a plurality of said outlets via a third tapping line associated with said third set, and a fourth tapping line associated with said fourth set.

This further increases flexibility for the operator when dispensing different types of beverages, such as different types of beer, as explained below.

Any of the first, second, third, fourth or optionally additional sets comprises one or more beverage containers, depending on the needs of the operator and/or consumption requirements. The first and second set may contain three beverage containers of a first type of beverage being dispensed from a first tapping head, as illustrated in the accompanying FIGURE. If the demand for this type of beverage is high, three beverage kegs in each set provide the required flexibility and proper time buffer for the operator.

If a second type of beverage which is dispensed from the second tapping head is in lower demand, then a third set of beverage kegs may only comprise one beverage keg, and also the fourth set of beverage kegs.

In any case, a plurality of beverage kegs, i.e. two or more, is connected to a corresponding valve in accordance with the present disclosure. In the example above, for the first type of beverage, six beverage kegs are used (three kegs in first and second set, respectively), while for the second type of beverage, two kegs are used (one in fourth and fifth set, respectively).

Thus, the valve is suitably a 3-way valve having two inlets and one outlet. The remote control means and the valve are in the near vicinity so that the operator can easily initiate the changing from the first set to the second set of kegs when the first set is empty of the first type of beverage being dispensed via the first tapping head; or for the second type of beverage being dispensed via the second tapping head, from the third to the fourth set of kegs. The same applies where e.g. the first or second set of kegs comprises one beverage container.

In another embodiment, each set of beverage containers comprises two or more beverage containers arranged in a staggered mannered, suitably by the outlet at the bottom of a first beverage container of a set of beverage containers being at a higher level than the outlet at the bottom of the second beverage container in same set, as e.g. disclosed in applicant's co-pending European patent application 17197309.2, in order to change in between collapsible kegs without interruption and also prevent foaming in the beverage line.

In another embodiment of the first aspect, said valve is electrically connected to said remote control means. The valve or valves are therefore separately actuated via the remote control means to open or close a corresponding tapping line.

In another embodiment of the first aspect, said valve is mechanically connected to said remote control means. The operator may therefore manually, directly and in a simple manner change to a given set of full beverage kegs, without the need of having electrical cables connected to the system. Thus, a much more simple and safe installation of the beverage system is possible. The valve acts therefore as a flip switch which the operator can readily handle from e.g. the bar counter or beverage counter.

In yet another embodiment of the first aspect, said remote control means and said valve are located in any of: said beverage side of the beverage counter, said bar counter, or said beverage font assembly. In particular, said valve may be integrated therein, for instance integrated in the beverage font, i.e. as part of the font, or integrated in the bar counter, or integrated in the beverage counter.

In another embodiment of the first aspect, the plurality of beverage containers is located at a remote location, such as at a different room within the drinking establishment, in particular a basement.

In a second aspect of the present disclosure, the above mentioned objects and more are achieved by a method of constructing a beverage dispensing system comprising a beverage dispensing region for a drinking establishment, by providing a plurality of beverage containers and one or more tapping heads for dispensing beverage in said beverage dispensing region, the one or more tapping heads having a beverage dispensing control means and a spout for dispensing beverage into a beverage recipient, each of said plurality of beverage containers including a beverage outlet in communication with said beverage, said method further comprising the steps of: installing a remote control means being connected to a valve, connecting said valve to a plurality of said beverage outlets for switching the dispensing of beverage from an empty beverage container to a full beverage container, and installing said remote control means and said valve in the near vicinity of said one or more tapping heads.

The method according to the second aspect may include any of the features of the embodiments of the first aspect.

In a third aspect, the present disclosure encompasses also a beverage dispensing system in which there is no remote control means being connected to a valve. Accordingly, there is provided a beverage dispensing system comprising a beverage dispensing region for a drinking establishment, said beverage dispensing region including a plurality of beverage containers and one or more tapping heads for dispensing beverage, the one or more tapping heads having a beverage dispensing control means and a spout for dispensing beverage into a beverage recipient, wherein each of said plurality of beverage containers includes a beverage outlet in communication with said beverage, in which the beverage dispensing system further comprises a valve, said valve being connected to a plurality of said beverage outlets for switching the dispensing of beverage from an empty beverage container to a full beverage container, and wherein said valve are located in the near vicinity of said one or more tapping heads.

This enables an even simpler system and/or installation, since the user, instead of using a remote control means to switch the valve or valves, may do it directly from the bar counter. In addition, the advantages already recited above in connection with the first and second aspect apply also, namely that the operator may manually, directly and in a simple manner change to a given set of full beverage kegs, without the need of having electrical cables connected to the system. Thus, a much more simple and safe installation of the beverage system is possible. The valve acts therefore as a flip switch which the operator can readily handle from e.g. the bar counter or beverage counter.

In an embodiment of the third aspect, said one or more tapping heads are mounted on a beverage counter, said beverage counter defining at least an operator side and a beverage side, said beverage side comprising at least one face, said one or more tapping heads protruding from the at least one face of said beverage side of said beverage counter, said one or more tapping heads being connectable to a tapping line comprising one or more beverage lines, said tapping line extending through said beverage side to any of said plurality of beverage containers, in which said beverage may flow from any of said plurality of beverage containers via said tapping line and said one or more tapping heads to said spout and from said spout to the beverage recipient, in which the at least one face is a vertical face and said one or more tapping heads are part of an assembly of tapping heads arranged along the horizontal direction of said vertical face.

In another embodiment of the third aspect, said one or more tapping heads are part of a beverage font in a beverage font assembly, said beverage font assembly comprising a bar counter, said beverage font being mounted in said bar counter, said bar counter defining an operator side and a customer side opposite said operator side, said one or more tapping heads having a spout and a beverage dispensing control means and being connectable to a tapping line comprising one or more beverage lines, said tapping line extending through said beverage font to any of said plurality of beverage containers, in which said beverage may flow from any of said plurality of beverage containers via said tapping line and said one or more tapping heads to said spout and from said spout to the beverage recipient.

According to the third aspect, the term “near vicinity of said one or more tapping heads” means: readily accessible to an operator located at a reaching distance of said one or more of said tapping heads, i.e. by the valve or set of valves being integrated in the beverage side of a beverage counter, or in a bar counter, or a beverage font assembly. The operator is located in the operator side, thus within reaching distance of the tapping heads.

The beverage dispensing system according to the third aspect may include any of the features of the embodiments of the first or second aspect.

### Cleaning

A further aspect of the present disclosure relates to utilization of the remote control and the valve of the presently disclosed system to provide cleaning of the system. Cleaning of beverage dispensing systems similar in overall structure to the presently disclosed system are described in applicant's patent applications WO 2010/029122, WO 2010/060946, WO 2011/117192 and PCT/EP2018/079437. These applications are hereby all are incorporated by reference in their entirety.

Generally seen cleaning of a beverage dispensing system typically requires a cleaning fluid that can be guided through the system, e.g. the tapping line and the tapping head, to remove any residual beverage from the system. A flushing fluid may also be provided subsequently to make sure that the cleaning fluid is removed. The cleaning system can be an integral part or and external part of the beverage dispensing system, and the cleaning fluid and/or the flushing fluid can be provided in external containers that are manually, semi-automatically of automatically connected to the beverage dispensing system when needed, in internal container(s) that fit into the pressure chamber(s) of the beverage dispensing system or in container(s) that engages with the pressure chamber such that the same pressure source can be used to dispense beverage from a beverage container in the pressure chamber and to provide cleaning and/or flushing fluid from a container engaged with the pressure chamber. Cleaning of the beverage dispensing system can for example be provided by means of one or more controllable valves that control whether the system is in beverage dispense mode or in cleaning mode. For example in cleaning mode the cleaning fluid can be forced through the tapping line(s), beverage line(s) and out through the tapping head(s) and spouts. Normally all tapping lines, beverage lines and all tapping heads are cleaned at the same time.

The presently disclosed remote control means connected to the valve may advantageously be utilized for cleaning of the beverage dispensing system, in particular only part of the beverage dispensing system, while other parts are still in use. As the valve(s) is located near the tapping heads it may also be utilized for circulating cleaning fluid and/or flushing fluid in the system, in particular in the tapping lines between the beverage outlets and the valve. In one embodiment the valve is configured for connecting two beverage outlets such that fluid and/or liquid, such as cleaning fluid and/or cleaning liquid, coming through a first beverage outlet originating from a first beverage container, at the location of the valve can be led into a second beverage outlet originating from a second beverage container, i.e. such that the first and second beverage outlets can be cleaned—and such that this cleaning can be controlled by the remotely controlled valve,

I.e. in addition to the valve being configured for switching the dispensing of beverage from a first of said beverage containers to at least a second of said beverage containers, it may further be configured for connecting corresponding tapping lines such that cleaning fluid and/or flushing fluid coming through a tapping line originating from a first beverage container, at the location of the remotely controlled valve can be led into the tapping line originating from the second beverage container. When the cleaning fluid and/flushing fluid reaches the location of the beverage containers, it can be discarded—in contrast to the normal procedure, where it is led out through tapping heads and discarded therefrom. An advantage of “shortcutting” the beverage lines by means of the valve near the tapping heads is that only the corresponding pair of beverage lines can be cleaned, whereas possibly remaining beverage lines and tapping heads are still in use. Thereby cleaning of a beverage dispensing system can be significantly more automatized because the valve can be remotely controlled, e.g. by a computer/processing unit such that cleaning of the beverage system can be provided almost automatically, e.g. during the night/closing hours of the drinking establishment.

Alternatively these tapping lines can also be connected at a location near the beverage containers, preferably at location adjacent the corresponding beverage outlets. The connection may be provided by an additional cleaning/discharge valve, and optionally a connecting line between the tapping lines. This additional (second) valve may possibly also be remotely controlled, preferably by the same remote control means, such that the cleaning fluid and/or flushing fluid can circulate in the tapping lines, instead of just being led out of the tapping heads. This may improve control of cleaning of the beverage dispensing system and reduce the use of cleaning fluid and/or flushing fluid.

As an example of cleaning functionality the presently disclosed system may further comprise a dispensing valve and a dispensing device may be provided. The dispensing valve may be included or accommodated in the dispensing device. The dispensing line typically defines a proximal end and a distal end, said proximal end being connected to a first connector and said distal end being connected to said dispensing valve, said dispensing valve having a closed and an open position, said open position allowing said beverage to be dispensed from said dispensing valve when said pressure chamber is pressurised, and said closed position preventing said beverage from being dispensed from said dispensing valve.

Cleaning fluid and flushing fluid may be provided in cartridges that may be configured to be arranged in, or engaged with, one or two of the pressure chambers.

For example in the form of a first cartridge containing a cleaning fluid for being positioned in said pressure chamber when pressurising said pressure chamber, and opening said dispensing valve, and dispensing said cleaning fluid from said dispensing valve, and causing said cleaning fluid to flow from said first cartridge past said first connector through said dispensing line and being dispensed from said dispensing valve, and for being removed after the emptying of said cleaning fluid from said first cartridge. And a second cartridge containing a flushing fluid for being positioned in a pressure chamber and pressurising said pressure chamber, and opening said dispensing valve and dispensing said flushing fluid from said dispensing valve, and causing said flushing fluid to flow from said second cartridge past said first connector through said dispensing line and being dispensed from said dispensing valve, and for being removed after the emptying of said flushing fluid from said second cartridge,

The first and second cartridge may be provided as a multi-chambered cartridge for arrangement in a single pressure chamber.

In particular WO 2010/060946 discloses a method of cleaning and flushing a beverage dispensing system that may be used herein. The beverage dispensing system comprises a sealable pressure chamber for receiving a collapsible keg containing a beverage, said pressure chamber having a first connector, said collapsible keg having a second connector for cooperating with and sealing against said first connector, said beverage dispensing system further comprising a fluid pressure source connected to said pressure chamber for pressurising said pressure chamber, a dispensing line, a dispensing valve, and a dispensing device, said dispensing valve being included or accommodated in said dispensing device, said dispensing line defining a proximal end and a distal end, said proximal end being connected to said first connector and said distal end being connected to said dispensing valve, said dispensing valve having a closed and an open position, said open position allowing said beverage to be dispensed from said dispensing valve when said pressure chamber is pressurised, and said closed position preventing said beverage from being dispensed from said dispensing valve, the method comprising the following steps:

(i) providing a first cartridge containing a cleaning fluid, (ii) positioning said first cartridge in said pressure chamber and connecting said first cartridge to said first connector, and pressurising said pressure chamber,

(iii) opening said dispensing valve and dispensing said cleaning fluid from said dispensing valve, and causing said cleaning fluid to flow from said first cartridge past said first connector through said dispensing line and being dispensed from said dispensing valve,

(iv) disconnecting said first cartridge from said first connector after the emptying of said cleaning fluid from said first cartridge, and removing said first cartridge,

(v) providing a second cartridge containing a flushing fluid, (vi) positioning said second cartridge in said pressure chamber and connecting said second cartridge to said first connector, and pressurising said pressure chamber, (vii) opening said dispensing valve and dispensing said flushing fluid from said dispensing valve, and causing said flushing fluid to flow from said second cartridge past said first connector through said dispensing line and being dispensed from said dispensing valve, and (viii) disconnecting said second cartridge from said first connector after the emptying of said cleaning fluid from said second cartridge, and removing said second cartridge.

### BRIEF DESCRIPTION OF DRAWINGS

The accompanying FIGURE is a perspective view of a beverage dispensing system according to the present disclosure including a beverage dispensing region comprising multiple tapping heads mounted on a beverage counter and a beverage font assembly comprising a font with multiple tapping heads mounted on a bar counter, and incorporating remote control means and connected valve(s), as well as a first set of collapsible beverage containers, in which two of the collapsible beverage containers are empty and one is nearly empty.

### DETAILED DESCRIPTION OF DRAWINGS

The sole FIGURE shows a perspective view of a beverage dispensing system 10 including beverage dispensing region 12 and beverage font assembly 14 at a point of sales of a drinking establishment. The beverage system incorporates remote control means 16 and connected valve(s) 18′ 18″ 18′″, as well as a first 20 and second set 22 of collapsible beverage containers 20a 20b 20c and 22a 22b 22c, respectively. In the first set 20, two of the collapsible beverage containers 20a 20b are empty and one 20c is nearly empty. In the second set 22, all three collapsible beverage containers 22a 22b 22c are full with beverage.

The point of sales represents the interface between operator side 26 at one side of bar counter 28 and a customer side 30 on the opposite side, with the font 32 comprising multiple tapping heads 34, here three. The point of sales includes also the beverage counter 36 which defines operator side 26 and beverage side 38. The beverage side 38 comprises a flat horizontal face 40 and flat vertical face 42, which may be a wall or a face embedded in a wall. A tapping head 44 as described above protrudes from vertical face and is in operation here as an operator (not shown) standing on the operator side 26 moves the tap handle into the beverage dispensing position so a beverage stream fills the beverage glass 46. A plurality of tapping heads 44 may be arranged along the horizontal direction of the vertical face to form an assembly. The tapping heads may also be arranged in vertical direction to form a suitable formation, such as a staggered formation as illustrated here. The beverage counter 36 may be significantly longer than schematically shown here and may comprise even 50 or 60 tapping heads protruding from the vertical face 42. The operator upon serving stands in the operator side 26 at any location along the edge 48 of the bar counter 28 or along the edge 50 of the beverage counter 36, while the customer stands in the customer side 30 at any location along the opposite edge (not shown) of the bar counter 28.

A remote control means 16, here simply exemplified as a remote control device comprising buttons is integrated in the beverage side 38 of beverage counter 36, here illustrated in the vertical face 42 and is readily accessible to the operator. An alternative location of the remote control means 16 is in the bar counter 28 as also shown in the FIGURE. A valve or set of valves 18′ 18″ 18′″, suitably 3-way valves, each associated to a tapping head 34′ 34″ 34′″ and each connected to the remote control means 16 as illustrated by electric cables 52, is integrated in the bar counter 28 and will be able to be separately actuated by the remote control means 16 to open a tapping line 54 56 corresponding to a specific set 20 22 of one or more collapsible beverage containers. Thus, the remote control means 16 and valve or set of valves 18′ 18″ 18′″ are located on or in the near vicinity of said one or more tapping heads 34 44, and readily accessible to an operator located at a reaching distance of said one or more of said tapping heads 34 44, e.g. by the remote control means 16 and valve or set of valves 18′ 18″ 18′″ being integrated in the beverage side 38 of the beverage counter 36, or in the bar counter 28, or in the beverage font assembly such as in the beverage font 32. Specifically in the embodiment of the FIGURE, the remote control means 16 are integrated in the beverage side 38 of the beverage counter 36, and the valve or set of valves 18′ 18″ 18′″ is integrated in the bar counter 28.

A first set 20 of collapsible beverage containers as a part of a beverage dispensing system 10 is shown in which two of the collapsible beverage containers 20a 20b are empty and the third and last one 20c is nearly empty. The collapsible beverage containers are encapsulated in respective pressure chambers 58a 58b 58c. Each of the beverage containers has a corresponding beverage outlet 60a 60b 60c at the bottom. Each of the pressure chambers 58a 58b 58c is also connected to a pressure line 62 which supplies compressed air to each of the pressure chambers. The pressure chambers are staggered with respect to each other such that the first collapsible beverage container 20a and the first outlet 60a at the bottom of this collapsible container 20a is located at a higher level than the second collapsible beverage container 20b encapsulated in the second pressure chamber 58b and its second outlet 60b, which in turn is located at a higher level than the third collapsible beverage container 20c and its third outlet 60c. Correspondingly, the first collapsible beverage container 20a is located at a higher level than the second collapsible beverage container 20b, which in turn is located at a higher level than the third collapsible beverage container 20c.

During dispensing, the first 20a and second beverage containers 20b already have crumpled or collapsed to their most crumpled state, i.e. the force applied by the pressure in the pressure space cannot crumple the beverage container any further. The beverage of the beverage containers has been dispensed through the first tapping line, which for illustration purposes corresponds to a tapping line 54 that continues to the associated first valve 18′ and then as first common tapping line 64 to the first tapping head 34′ in font 32, as it is explained below. The gas of the head space 66a 66b is located partially in the crumpled beverage container, a first portion of the tapping line 54 connected to beverage container 20a and partly also in the second portion of tapping line 54 connected to beverage container 20b, as illustrated in the FIGURE by the empty portion of tapping line 54 immediately after the junction below collapsible beverage container 20b. The gas in the head space 66a 66b does not reach a junction 68 below collapsible beverage container 20c since the volume of the above empty portion of the tapping line part is greater than the volume of the head space 66b. Thus, a small amount of beverage from the beverage space remains in the second portion of the tapping line 54 adjacent the junction 68; no gas enters the tapping head and no foam is generated. Dispensing can continue without interruption from beverage container 20c. No gas can enter the third tapping line part until the third container 20c is empty and the gas from the head space 66c enters the third tapping line part that combines into single tapping line 54.

A first tapping head 34′ may be associated via a first common tapping line 64 with a first 20 and second set 22 of collapsible beverage containers, each set having e.g. one to three collapsible beverage containers, all containing a first type of beverage, such as a first type of beer 70 which is dispensed from the first tapping head 34′. From the first set 20 of collapsible beverage containers, the first tapping line 54 of the first set 20 extends to a first valve 18′ connected to the remote control means 16 and adjacent to the first tapping head 34′, for instance integrated in the bar counter 28. The valve(s) 18 may also be integrated in the beverage counter 36. From the second set 22 of collapsible beverage containers, a second tapping line 56 of the second set extends to the same first valve 18′. From the first valve 18′, the above mentioned first common tapping line 64 extends into the first tapping head 18′ and is dispensed to the customer located in customer side 30. When the last of the collapsible beverage containers 20c of the first set 20 is empty, the operator standing in operator side 26 via the remote control means 16, or even directly by manual operation, actuates the first valve 18′ to open the second tapping line 56 of the second set 22.

A second tapping head 34″ may be associated via a second common tapping line 72 with a third and fourth set of collapsible beverage containers, e.g. one to three collapsible beverage containers (not shown), all containing a second type of beer which is dispensed from the second tapping head 34″. A second valve 18″ switches between a third tapping line 74 and a fourth tapping line 76 and from this second valve 18″, the above second common tapping line 72 extends into the second tapping head 34″ and the second type of beer is dispensed to the customer.

A third tapping head may be associated via a third common tapping line with a fifth and sixth set of collapsible beverage containers, e.g. one to three collapsible beverage containers, all containing a third type of beer which is dispensed from the third tapping head, and so forth.

### REFERENCE NUMERALS

10. Beverage dispensing system

12. Beverage dispensing region

14. Beverage font assembly

16. Remote control means

18. Valve(s)

20. First set of collapsible beverage containers

22. Second set of collapsible beverage containers

26. Operator side

28. Bar counter

30. Customer side

32. Beverage font

34. Tapping head(s)

36. Beverage counter

38. Beverage side

40. Flat horizontal face

42. Flat vertical face

44. Tapping head(s)

46. Beverage glass

48. Edge of bar counter

50. Edge of beverage counter

52. Electric cables

54. Tapping line for first set of collapsible beverage containers

56. Tapping line for second set of collapsible beverage containers

58. Pressure chamber(s)

60. Beverage outlet(s)

62. Pressure line

64. First common tapping line

66. Head space

68. Junction

70. First type of beverage

72. Second common tapping line

74. Tapping line for third set of collapsible beverage containers

76. Tapping line for fourth set of collapsible beverage containers

### POINTS OF THE INVENTION

1. A beverage dispensing system comprising a beverage dispensing region for a drinking establishment, said beverage dispensing region including a plurality of beverage containers and one or more tapping heads for dispensing beverage, the one or more tapping heads having a beverage dispensing control means and a spout for dispensing beverage into a beverage recipient, wherein each of said plurality of beverage containers includes a beverage outlet in communication with said beverage, in which the beverage dispensing system further comprises a remote control means being connected to a valve, said valve being connected to a plurality of said beverage outlets for switching the dispensing of beverage from an empty beverage container to a full beverage container, and wherein said remote control means and said valve are located in the near vicinity of said one or more tapping heads.

2. A beverage dispensing system according to point 1, wherein said remote control means comprises a remote control button or a switch.

3. A beverage dispensing system according to point 1 or 2, wherein said remote control means is part of a touch screen and said touch screen provides a visual display of the content of beverage within a particular beverage container.

4. A beverage dispensing system according to any preceding point, wherein said one or more tapping heads are mounted on a beverage counter, said beverage counter defining at least an operator side and a beverage side, said beverage side comprising at least one face, said one or more tapping heads protruding from the at least one face of said beverage side of said beverage counter, said one or more tapping heads being connectable to a tapping line comprising one or more beverage lines, said tapping line extending through said beverage side to any of said plurality of beverage containers, in which said beverage may flow from any of said plurality of beverage containers via said tapping line and said one or more tapping heads to said spout and from said spout to the beverage recipient, in which the at least one face is a vertical face and said one or more tapping heads are part of an assembly of tapping heads arranged along the horizontal direction of said vertical face.

5. A beverage dispensing system according to any of points 1 to 3, wherein said one or more tapping heads are part of a beverage font in a beverage font assembly, said beverage font assembly comprising a bar counter, said beverage font being mounted in said bar counter, said bar counter defining an operator side and a customer side opposite said operator side, said one or more tapping heads having a spout and a beverage dispensing control means and being connectable to a tapping line comprising one or more beverage lines, said tapping line extending through said beverage font to any of said plurality of beverage containers, in which said beverage may flow from any of said plurality of beverage containers via said tapping line and said one or more tapping heads to said spout and from said spout to the beverage recipient.

6. A beverage dispensing system according to any preceding point, wherein said beverage containers are collapsible beverage containers, preferably single use collapsible beverage containers.

7. A beverage dispensing system according to any preceding point, wherein the beverage dispensing system comprises between 3 and 50 beverage containers.

8. A beverage dispensing system according to any preceding point, wherein said plurality of beverage containers including a beverage outlet in communication with said beverage is part of a first and second set of beverage containers, each set comprising one or more beverage containers.

9. A beverage dispensing system according to point 8, further comprising at least a third set and fourth set of beverage containers, each set comprising one or more beverage containers.

10. A beverage dispensing system according to any of points 8-9, wherein each set of beverage containers comprises two or more beverage containers arranged in a staggered manner.

11. A beverage dispensing system according to any preceding point, wherein said valve is electrically connected to said remote control means.

12. A beverage dispensing system according to any preceding point, wherein said valve is mechanically connected to said remote control means.

13. A beverage dispensing system according to any preceding point, wherein said remote control means and said valve are located in any of: said beverage side of the beverage counter, said bar counter, or said beverage font assembly.

14. A beverage dispensing system according to any preceding point, wherein the beverage container is located at a remote location, such as at a different room within the drinking establishment, in particular a basement.

15. A method of constructing a beverage dispensing system comprising a beverage dispensing region for a drinking establishment, by providing a plurality of beverage containers and one or more tapping heads for dispensing beverage in said beverage dispensing region, the one or more tapping heads having a beverage dispensing control means and a spout for dispensing beverage into a beverage recipient, each of said plurality of beverage containers including a beverage outlet in communication with said beverage, said method further comprising the steps of:
installing a remote control means being connected to a valve,
connecting said valve to a plurality of said beverage outlets for switching the dispensing of beverage from an empty beverage container to a full beverage container, and
installing said remote control means and said valve in the near vicinity of said one or more tapping heads.

16. A beverage dispensing system in which there is no remote control means being connected to a valve. Accordingly, there is provided a beverage dispensing system comprising a beverage dispensing region for a drinking establishment, said beverage dispensing region including a plurality of beverage containers and one or more tapping heads for dispensing beverage, the one or more tapping heads having a beverage dispensing control means and a spout for dispensing beverage into a beverage recipient, wherein each of said plurality of beverage containers includes a beverage outlet in communication with said beverage, in which the beverage dispensing system further comprises a valve, said valve being connected to a plurality of said beverage outlets for switching the dispensing of beverage from an empty beverage container to a full beverage container, and wherein said valve are located in the near vicinity of said one or more tapping heads.

17. A beverage dispensing system according to point 16, wherein said one or more tapping heads are mounted on a beverage counter, said beverage counter defining at least an operator side and a beverage side, said beverage side comprising at least one face, said one or more tapping heads protruding from the at least one face of said beverage side of said beverage counter, said one or more tapping heads being connectable to a tapping line comprising one or more beverage lines, said tapping line extending through said beverage side to any of said plurality of beverage containers, in which said beverage may flow from any of said plurality of beverage containers via said tapping line and said one or more tapping heads to said spout and from said spout to the beverage recipient, in which the at least one face is a vertical face and said one or more tapping heads are part of an assembly of tapping heads arranged along the horizontal direction of said vertical face.

18. A beverage dispensing system according to point 16, wherein said one or more tapping heads are part of a beverage font in a beverage font assembly, said beverage font assembly comprising a bar counter, said beverage font being mounted in said bar counter, said bar counter defining an operator side and a customer side opposite said operator side, said one or more tapping heads having a spout and a beverage dispensing control means and being connectable to a tapping line comprising one or more beverage lines, said tapping line extending through said beverage font to any of said plurality of beverage containers, in which said beverage may flow from any of said plurality of beverage containers via said tapping line and said one or more tapping heads to said spout and from said spout to the beverage recipient.

19. A beverage dispensing system according to any of points 16-18, wherein said beverage containers are collapsible beverage containers, preferably single use collapsible beverage containers.

20. A beverage dispensing system according to any of points 16-19, wherein the beverage dispensing system comprises between 3 and 50 beverage containers.

21. A beverage dispensing system according to any of points 16-20, wherein said plurality of beverage containers including a beverage outlet in communication with said beverage is part of a first and second set of beverage containers, each set comprising one or more beverage containers.

22. A beverage dispensing system according to point 21, further comprising at least a third set and fourth set of beverage containers, each set comprising one or more beverage containers.

23. A beverage dispensing system according to any of points 21-22, wherein each set of beverage containers comprises two or more beverage containers arranged in a staggered manner.

24. A beverage dispensing system according to any of points 16-23, wherein said remote control means and said valve are located in any of: said beverage side of the beverage counter, said bar counter, or said beverage font assembly.

25. A beverage dispensing system according to any of points 16-24, wherein the beverage container is located at a remote location, such as at a different room within the drinking establishment, in particular a basement.

1. A beverage dispensing system comprising a beverage dispensing region for a drinking establishment, said beverage dispensing region including a plurality of beverage containers and one or more tapping heads for dispensing beverage, the one or more tapping heads having a beverage dispensing control means and a spout for dispensing beverage into a beverage recipient, wherein each of said plurality of beverage containers includes a beverage outlet in communication with said beverage, in which the beverage dispensing system further comprises a remote control means being connected to a valve, said valve being connected to a plurality of said beverage outlets and configured for:
switching the dispensing of beverage from a first of said beverage containers to at least a second of said beverage containers, and/or
connecting two beverage outlets such that fluid coming through a first beverage outlet originating from a first beverage container, at the location of the valve can be led into a second beverage outlet originating from a second beverage container, and
wherein said remote control means and said valve are located in the near vicinity of said one or more tapping heads.

2. A beverage dispensing system according to claim 1, wherein said remote control means comprises a remote control button or a switch.

3. A beverage dispensing system according to claim 1 or 2, wherein said remote control means is part of a touch screen and said touch screen provides a visual display of the content of beverage within a particular beverage container.

4. A beverage dispensing system according to any preceding claim, wherein the first beverage container is an empty beverage container and the second beverage container is a full beverage container.

5. A beverage dispensing system according to any preceding claim, wherein the first beverage container contains a first type of beverage and the least second beverage container contains at least a second and different type of beverage.

6. A beverage dispensing system according to any preceding claim, wherein the first beverage container contains alcohol free beer and the second beverage container contains beer with alcohol.

7. A beverage dispensing system according to any preceding claim, wherein the first beverage container contains a beverage and the second beverage container contains a cleaning fluid and/or flushing fluid for cleaning said system.

8. A beverage dispensing system according to any preceding claim, wherein said fluid is cleaning fluid and/or flushing fluid.

9. A beverage dispensing system according to any preceding claim, wherein said one or more tapping heads are mounted on a beverage counter, said beverage counter defining at least an operator side and a beverage side, said beverage side comprising at least one face, said one or more tapping heads protruding from the at least one face of said beverage side of said beverage counter, said one or more tapping heads being connectable to a tapping line comprising one or more beverage lines, said tapping line extending through said beverage side to any of said plurality of beverage containers, in which said beverage may flow from any of said plurality of beverage containers via said tapping line and said one or more tapping heads to said spout and from said spout to the beverage recipient, in which the at least one face is a vertical face and said one or more tapping heads are part of an assembly of tapping heads arranged along the horizontal direction of said vertical face.

10. A beverage dispensing system according to any of claims 1 to 9, wherein said one or more tapping heads are part of a beverage font in a beverage font assembly, said beverage font assembly comprising a bar counter, said beverage font being mounted in said bar counter, said bar counter defining an operator side and a customer side opposite said operator side, said one or more tapping heads having a spout and a beverage dispensing control means and being connectable to a tapping line comprising one or more beverage lines, said tapping line extending through said beverage font to any of said plurality of beverage containers, in which said beverage may flow from any of said plurality of beverage containers via said tapping line and said one or more tapping heads to said spout and from said spout to the beverage recipient.

11. A beverage dispensing system according to any preceding claim, wherein said beverage containers are collapsible beverage containers, preferably single use collapsible beverage containers.

12. A beverage dispensing system according to any preceding claim, wherein the beverage dispensing system comprises between 3 and 50 beverage containers.

13. A beverage dispensing system according to any preceding claim, wherein said plurality of beverage containers including a beverage outlet in communication with said beverage is part of a first and second set of beverage containers, each set comprising one or more beverage containers.

14. A beverage dispensing system according to claim 13, further comprising at least a third set and fourth set of beverage containers, each set comprising one or more beverage containers.

15. A beverage dispensing system according to any of claims 13-14, wherein each set of beverage containers comprises two or more beverage containers arranged in a staggered manner.

16. A beverage dispensing system according to any preceding claim, wherein said valve is electrically connected to said remote control means.

17. A beverage dispensing system according to any preceding claim, wherein said valve is mechanically connected to said remote control means.

18. A beverage dispensing system according to any preceding claim, wherein said remote control means and said valve are located in any of: said beverage side of the beverage counter, said bar counter, or said beverage font assembly.

19. A beverage dispensing system according to any preceding claim, wherein the beverage container is located at a remote location, such as at a different room within the drinking establishment, in particular a basement.

20. A method of constructing a beverage dispensing system comprising a beverage dispensing region for a drinking establishment, by providing a plurality of beverage containers and one or more tapping heads for dispensing beverage in said beverage dispensing region, the one or more tapping heads having a beverage dispensing control means and a spout for dispensing beverage into a beverage recipient, each of said plurality of beverage containers including a beverage outlet in communication with said beverage, said method further comprising the steps of:
installing a remote control means being connected to a valve,
connecting said valve to a plurality of said beverage outlets for
switching the dispensing of beverage from a first of said beverage containers to at least a second of said beverage containers, and/or
connecting two beverage outlets such that fluid coming through a first beverage outlet originating from a first beverage container, at the location of the valve can be led into a second beverage outlet originating from a second beverage container, and
installing said remote control means and said valve in the near vicinity of said one or more tapping heads.
